(19) United States
(12) Patent Application Publication
(10) Pub. No.: US 2011/0020101 A1
(43) Pub. Date: Jan. 27, 2011

(54) Vegetation cutter support assembly

(76) Inventors: Paul W. Crane, Livingston, LA (US); Thomas J. Donaldson, Gonzales, LA (US)

Correspondence Address: KEATY LAW FIRM, LLC, 365 CANAL STREET, Suite 2410, NEW ORLEANS, LA, 70130, US

(21) Appl. No.: 12/460,637

(22) Filed: Jul. 22, 2009

(51) Int. Cl. B66C 23/00

(52) U.S. Cl. 414/680

(57) ABSTRACT

A support assembly for a vegetation-cutting unit is mountable on an all-terrain vehicle or other suitable vehicle. The propelling vehicle has an undercarriage frame, on which the support assembly is suspended. An undercarriage support bar is configured for detachable mounting on the undercarriage frame and an elongated lift arm is pivotally secured to the undercarriage support bar. A free end of the lift arm has a U-shaped yoke, which is secured to the vegetation-cutting unit. The bent aspect of the lift arm allows vegetation cutting along a steep slope.

### BACKGROUND OF THE INVENTION

This invention relates to a support assembly for a work unit, such as a grass mower configured to support the grass mower from an all-terrain vehicle (ATV) or other propelling vehicle.

Grass cutting or mowing has been performed using a variety of equipment, including ride-on mowers, self-propelled mowers, push mowers and other types of machinery. In most cases, the mowing equipment operates well when the ground level is relatively even. However, this equipment becomes unusable when a bank of a creek or a ditch must be mowed. The problem is exacerbated when the slope extends at 45-degrees or more in relation to the bank. In such cases, conventional mowers cannot be used, necessitating the use of professional services that employ tractors or other such equipment. Professional services may be prohibitively expensive, which leaves the property owner with limited options.

The present invention contemplates elimination of drawbacks associated with conventional equipment and provision of an attachment assembly that can be mounted to an all-terrain vehicle and extend the reach of a work unit, such as a vegetation cutter on an elongated boom into a ditch or along a steep slope.

### SUMMARY OF THE INVENTION

It is, therefore, an object of the present invention to provide a support assembly for a lawn mower that can be secured to an all-terrain vehicle.

It is another object of the invention to provide an attachment assembly for an all-terrain vehicle that is configured to support a work unit, such as a grass mower.

These and other objects of the invention are achieved through a provision of a support assembly for a vegetation-cutting unit, such as a grass mower mountable on an all-terrain vehicle having an undercarriage frame. The support assembly comprises an undercarriage support bar, which can be attached to the undercarriage frame by a plurality of U-bolts. An elongated lift arm is secured to one end of the undercarriage support bar, while one or more counterweights are detachably secured to the opposite end of the undercarriage support bar so as to stabilize the four-wheeler during operation and prevent its overturning.

The lift arm has a bent aspect allowing a vegetation-cutting unit to be suspended from the lift arm. A winch assembly is operationally connected to the lift arm and is adapted to impart a limited pivotal movement on the lift arm for better maneuverability of the cutting unit.

### BRIEF DESCRIPTION OF THE DRAWINGS

Reference will now be made to the drawings, wherein like parts are designated by like numerals, an wherein

FIG. 1 is a perspective view of the assembly of the present invention mounted on an all-terrain vehicle.

FIG. 2 is an exploded view of the attachment assembly of the present invention.

FIG. 3 is a detail view illustrating the attachment bolts securing the assembly to the four-wheeler frame.

FIG. 4 is a detail view illustrating securing of the lower lift arm to the under carriage support bar.

FIG. 5 is a detail view illustrating securing of the U-shaped yoke to the slotted bar mounted on the mower deck.

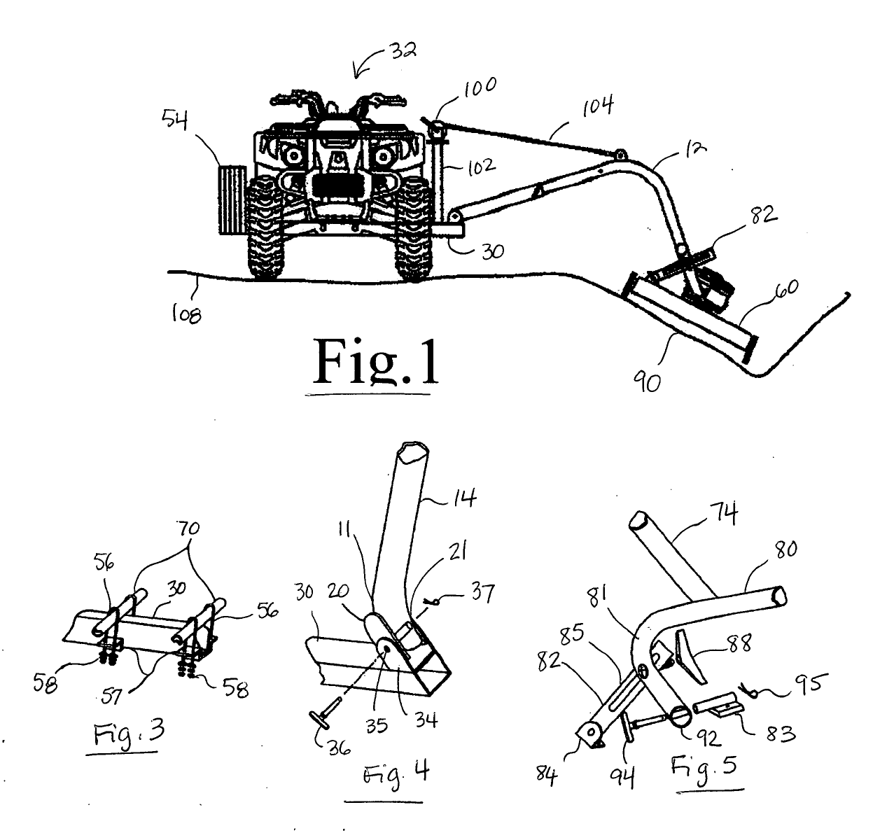

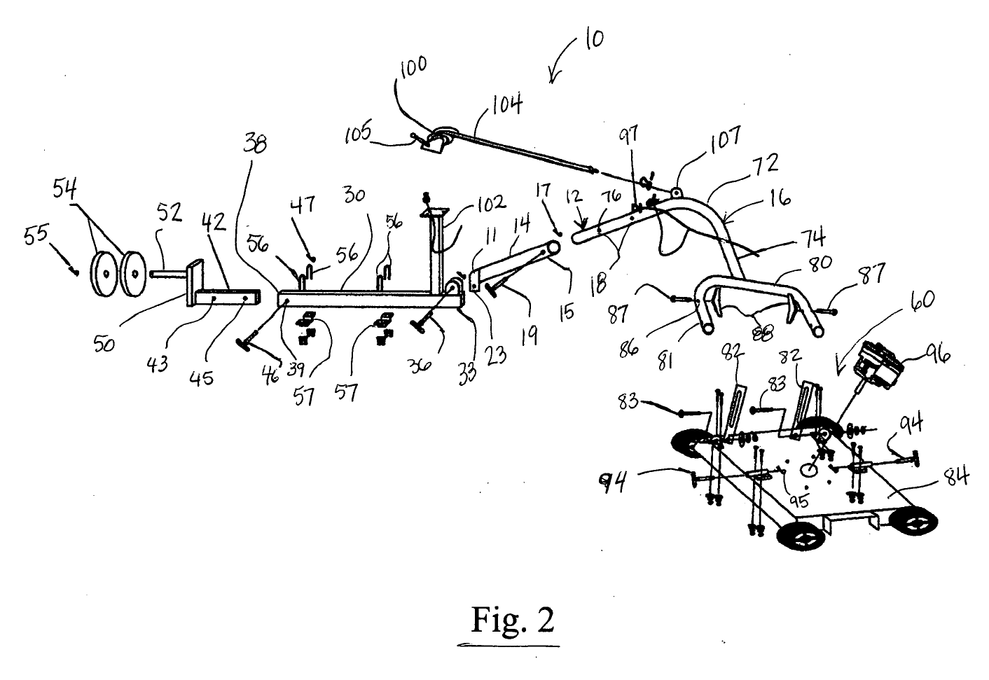

### DETAIL DESCRIPTION OF THE INVENTION

Turning now to the drawings in more detail, numeral 10 designates the support assembly of the present invention. The assembly 10 comprises an elongated telescoping arm 12 having a lower lift arm member 14 and an upper lift arm member 16. The upper lift arm 16 telescopically engages with the lower lift arm 14. A plurality of spaced-apart through openings 18 are formed in the upper lift arm 16, the openings 18 being configured to receive a hitch pin 19, which secures the upper lift arm 16 to the lower lift arm 14. A washer 17 engages the hitch pin 19 on a diametrically opposite side of the opening 18, thus securing the upper lift arm 16 in a position selected by the user. A through opening 15 is formed in a distant end of the lower lift arm 14 for receiving the hitch pin 19 once the opening 15 is aligned with one of the selected openings 18. By using any of the spaced openings 18, the user can extend the reach of the arm 12 when required.

A proximate end of the lower lift arm 14 is bent, as at 11, and carries a pair of flat plates 20, 21 attached to opposite sides of the lower lift arm 14. The plates 20, 21 are provided with co-axial openings 23. An undercarriage support bar 30 extends below the bottom of the all-terrain vehicle 32. Of course, any other stable vehicle can be used, such as a small four-wheeler.

A proximate end 33 of the undercarriage support bar 30 carries a pair of parallel mounted brackets 34, which are provided with openings 35. A hitch pin 36 is detachably positioned through the openings 35 and 23 to engage the lower lift arm 14 to the undercarriage support bar 30. A suitable washer 37 secures the hitch pin 37 within the openings 23 and 35, preventing the lower lift arm 14 from disengaging from the undercarriage support bar 30.

A distant end 38 of the undercarriage support bar 30 is provided with a pair of through openings 39, which receive a hitch pin 40 therethrough. A counterweight support bar 42 is configured to telescopically engage within the undercarriage support bar 30. A plurality of spaced apart openings 43, 45 is formed in the counterweight support bar 42. When any of the selected openings 43 or 45 are aligned with the openings 39, a hitch pin 46 is inserted through the aligned openings and is secured on the opposite side of the undercarriage support bar 30 with a washer 47.

The counterweight support bar 42 carries a transversely extending stop plate 50 at a distant end thereof. A counterweight support rod 52 is secured to a side of the stop plate 50 opposite the counterweight support bar 42. The counterweight support rod 52 extends outwardly from the stop plate 50 and is oriented in a substantially parallel relationship to the counterweight support bar 42. One or more counterweights 54 are provided for stabilizing the vehicle 32 in counterbalance to the weight of the work unit 60.

The counterweights 54 are each provided with a central opening allowing to mount them on the counterweight support rod 52. A washer 55 is engaged with the end of the counterweight support rod 52 once one or more counterweights 54 are mounted on the counterweight support rod 52. The counterweights 54 are adjustable in weight and can be selected to differ in mass, depending on the weight of the work unit 60, the angle of the slope, etc.

The undercarriage support bar 30 is detachably secured under the four-wheeler 32 using a set of U-shaped bolts 56, which are detachably engaged with the undercarriage support bar 30 and secured thereto by using brackets 57 and lock nut-washer assembly 58. As can be seen in detail in FIG. 3, the U-bolts 56 are mounted over the frame members 70 of the vehicle 32, while the undercarriage support bar 30 is mounted below the frame members 70. The U-bolts 56 engage the frame members 70 on opposite sides of the undercarriage support bar 30, while the brackets 57 support the undercarriage support bar 30 from the bottom. The ends of the U-bolts 56 are engage with the lock-nut-washer assemblies 57, preventing shifting of the undercarriage support bar 30.

The upper lift arm 16 is bent downwardly, as at 72, allowing the distant end 74 to extend at approximately right angle in relation to the telescopic end 76 of the upper lift arm 16. A yoke 80 is secured to the distant end 74. The yoke 80 has a generally U-shaped configuration. Each of the arms 81 of the yoke 80 is secured to a slotted bar 82, which is mounted on a deck 84 of the work unit 60, which can be a grass mower, a trimmer or the like.

The slotted bars 82 extend upwardly from the deck 84, being secured to the deck by bolts 83 engaged with deck-mounted brackets 84 (FIG. 5). Each bar 82 is provided with an elongated slot 85. Each of the arms 81 is provided with an opening 86, through which a bolt 87 extends. A wing nut 88 engages a free end of the bolt 87. The bolt slides within the slot 85 allowing a limited adjustment in the position of the work unit 60 depending on the degree of a slope 90, along which the work unit 60 is propelled by the all-terrain vehicle 32.

Free ends 92 of the yoke arms 81 are secured to the deck 84 of the mower 60 using a bracket 93, a hitch pin 94 and a washer 95, as shown in FIG. 5. The yoke 80 is allowed a limited pivotal movement about an axis defined by the pin 94.

A small winch 100 is mounted on a pedestal 102, which is secured to the undercarriage support bar 30 and extends upwardly therefrom. A cable or rope 104 is coiled on the winch 100 allowing to slightly lift and lower the lift arm 12, while pivoting the work unit 60. The winch 100 may be a hand-operated device with a handle 105 or an electrically-operated device. The rope 104 passes through a shackle 107, which is attached to the lift arm 12 adjacent the bent portion 72.

Conventional work units 60 have a gasoline-powered motor 96, which is started by pulling a string, or rope 97. A handle attached to the rope 97 may be secured to the lower lift arm 14 within easy reach of a rider of the four-wheeler 32.

In operation, a user attaches the undercarriage support bar 30 to the frame members 70 of the four-wheeler 32. The pedestal 102 is located on the right or left side of the four-wheeler 32, depending on the direction of travel and the location of the slope 90. The user then secures the upper lift arm 16 to the deck of the work unit 60 and then adjustably secures the lower lift arm 14 to the upper lift arm 16. The user then secures the necessary mass of the counterweights 54 to stabilize the four-wheeler 32 during operation.

The work unit 60 is then started and the four-wheeler is propelled along the bank 108 of the ditch 90, while the work unit 60 is propelled at a level below and at a steep angle to, the bank 108. The counterweights 54 located on the side of the vehicle opposite the arm 12 prevent overturning of the vehicle 32 during operation. The winch 100 allows the rider to adjust position of the work unit 60 to facilitate an efficient grass or vegetation cutting.

It is envisioned that the attachment assembly of the present invention may be also used with “zero turn” work units and other gardening implements where extension from a propelled vehicle is required. The support assembly can be used for supporting different work units, particularly the units for cutting vegetation along steep slopes. The length of the lift arm 12 can be varied, just as the number and mass of the counterweights 54 to accommodate different applications. It is also envisioned that the attachment assembly of the instant invention may be sold as a kit for retrofitting an existing four-wheeler and that the assembly 10 may be mounted and dismounted from the four-wheeler as the user elects.

The position of the undercarriage support bar can be easily changed, allowing the user to suspend the grass mower from the opposite side of the four-wheeler and perform the grass cutting operation on the opposite slope.

Many changes and modifications can be made in the design of the present invention without departing from the spirit thereof. I, therefore, pray that my rights to the present invention be limited only by the scope of the appended claims.

I claim:

1. A support assembly for a work unit mountable on an all-terrain vehicle having an undercarriage frame, the support assembly comprising:
an undercarriage support bar configured for detachable mounting on the undercarriage frame and having a first end and a second end;
an elongated lift arm having a proximate end configured for detachable securing to the first end of the undercarriage support bar and a distant end configured for detachable securing to the work unit; and
a counterweight member detachably securable to the second end of the undercarriage support bar.

2. The apparatus of claim 1, further comprising a pedestal support extending upwardly from the undercarriage support bar.

3. The apparatus of claim 2, further comprising a winch assembly mounted on the pedestal support, said winch assembly is provided with a cable, one end of the cable being secured to the elongated lift arm, and wherein operation of the winch assembly facilitates a limited vertical movement of the lift arm.

4. The apparatus of claim 1, wherein said lift arm comprises a lower lift arm member pivotally secured to the first end of the undercarriage support bar and an upper lift arm member telescopically engaging the lower lift arm member.

5. The apparatus of claim 4, wherein the upper lift arm member has a first portion telescopically engaging the lower lift arm member and a second portion extending downwardly at an angle in relation to the first portion.

6. The apparatus of claim 5, further comprising a U-shaped yoke secured to a free end of the second portion of the upper lift arm member, said yoke having a pair of spaced yoke arms configured for detachable securing to the work unit.

7. The apparatus of claim 6, further comprising a pair of slotted bars detachably securable to the work unit.

8. The apparatus of claim 7, wherein said yoke arms are engaged with the slotted bars and are configured for a limited movement within limits defined by the slotted bars.

9. The apparatus of claim 1, further comprising a means for detachable mounting of the undercarriage support bar to the frame of the all-terrain vehicle.

10. The apparatus of claim 9, wherein said means for detachable mounting comprises a plurality of U-shaped bolts engaging the frame of the all-terrain vehicle and the undercarriage support bar.

11. The apparatus of claim 1, further comprising a stop plate mounted in a transverse relationship to the second end of the undercarriage support bar, said stop plate carrying a counterweight support rod, and wherein the counterweight member is configured for selective mounting on said counterweight support rod.

12. A support assembly for a grass mower mountable on an all-terrain vehicle having an undercarriage frame, the support assembly comprising:
an undercarriage support bar configured for detachable mounting on the undercarriage frame and having a first end and a second end;
an elongated lift arm having a proximate end configured for detachable securing to the first end of the undercarriage support bar and a distant end configured for detachable securing to the grass mower, said lift arm being configured for a limited pivotal movement in relation to the undercarriage support bar;
a counterweight member detachably securable to the second end of the undercarriage support bar; and
a winch assembly operationally connected to the lift arm and adapted to impart a limited pivotal movement on the lift arm.

13. The apparatus of claim 12, further comprising an upright pedestal member extending from the undercarriage support bar adjacent the first end of the undercarriage support bar, and wherein the winch assembly is secured to the pedestal member.

14. The apparatus of claim 12, wherein said lift arm comprises a lower lift arm member pivotally secured to the first end of the undercarriage support bar and an upper lift arm member telescopically engaging the lower lift arm member, said upper lift arm member being selectively extendable in relation to the lower lift arm member.

15. The apparatus of claim 14, wherein the upper lift arm member has a first portion telescopically engaging the lower lift arm member and a second portion extending downwardly at an angle in relation to the first portion.

16. The apparatus of claim 15, further comprising a U-shaped yoke secured to a free end of the second portion of the upper lift arm member, said yoke having a pair of spaced yoke arms configured for detachable securing to the grass mower.

17. The apparatus of claim 14, further comprising a means for securing the lift arm to the grass mower.

18. The apparatus of claim 17, wherein said securing means comprises a pair of spaced-apart slotted bars mounted on said grass mower, said upper lift arm member comprises a U-shaped yoke with a pair of yoke arms, and wherein the yoke arms are configured to engage the slotted bars, while being adapted for a transverse movement in relation to the slotted bars within limits defined by the slotted bars.

19. The apparatus of claim 12, further comprising a means for detachable mounting of the undercarriage support bar to the frame of the all-terrain vehicle.

20. The apparatus of claim 19, wherein said means for detachable mounting comprises a plurality of U-shaped bolts engaging the frame of the all-terrain vehicle and the undercarriage support bar.

21. The apparatus of claim 12, further comprising a stop plate mounted in a transverse relationship to the second end of the undercarriage support bar, said stop plate carrying a counterweight support rod, and wherein the counterweight member is configured for selective mounting on said counterweight support rod.
